(19) United States
(12) Patent Application Publication
(10) Pub. No.: US 2009/0064314 A1
(43) Pub. Date: Mar. 5, 2009

(54) Method and Apparatus for Implementing Parental Controls for a Portable Media Device

(76) Inventor: Michael M. Lee, San Jose, CA (US)

Correspondence Address: TECHNOLOGY & INNOVATION LAW GROUP, PC, ATTN: 101, 19200 STEVENS CREEK BLVD., SUITE 240, CUPERTINO, CA, 95014, US

(21) Appl. No.: 11/848,995

(22) Filed: Aug. 31, 2007

(51) Int. Cl. G06F 7/04

(52) U.S. Cl. 726/17

(57) ABSTRACT

Methods and apparatus which allow parents to control the access of their children to features of a portable electronic device are disclosed. According to one aspect, a method for controlling the use of features associated with a portable electronic device includes setting at least one constraint associated with access to a feature of the portable electronic device and processing a user request to access the feature. The method can also include determining whether the constraint indicates that the feature is currently accessible to the user, and permitting access to the feature when the indication is that the feature is currently accessible to the user. Finally, access to the feature can be denied if the indication is that the feature is not currently accessible to the user.

### BACKGROUND OF THE INVENTION

1. Field of the Invention

The present invention relates to portable electronic media devices such as digital music players and cellular phones and, more particularly, to control of usage of portable electronic media devices.

2. Description of the Related Art

Media, e.g., audio media or video media, that children consume typically has an impact on their lives. Exposure to the media may have both a positive impact and a negative impact on the lives of children. As such, there is a need for adults, particularly parents, to establish access rules that pertain to the accessibility of media to children. Such access rules may relate to choosing, managing and using media.

Children's advocates are divided when it comes to appropriate and effective solutions for controlling access to media. However, it is generally believed that parents should set limits on access to media, and, further, that parents should instill values in their children that make the children aware of why access to certain media should be limited. With regards to television, for example, many children's advocates provide guidelines including, but not limited to including, limiting the number of television-viewing hours, keeping televisions out of a child's bedroom, not watching television during meals, not allowing a child to watch television while working on school work, and only allowing television to be viewed after chores and school work are completed.

Some mechanisms have been developed and implemented to aid parents in controlling access to media. For example, many televisions, video players, and cable boxes are equipped with a V-Chip, which provides functionality that allows parents to block access to television programs based on their rating categories. In addition, some computer programs provide parental controls for limiting computer usage, limiting access to the Internet, setting time limits for the computer itself, and/or setting time limits regarding access to certain applications running on the computer.

As portable electronic devices such as portable media players, cellular phones, game players, and music players phones become increasingly popular, the ability for parents to control their child's exposure to media is becoming more difficult. Such portable electronic devices are popular with children, and are often used by children outside of their homes, away from the watchful eyes of parents. The number of children who possess such devices is growing rapidly, and the age at which children obtain these devices is dropping.

Few mechanisms are available for use with portable electronic devices to provide parents with the ability to control access to media. Some cellular phone companies, for instance, have created child-friendly cellular phones that allow a parent to set limits on usage, as well as to create sets of approved phone numbers that may be dialed and prohibited phone numbers that may not be dialed. In addition, some music players are equipped with features that allow parents to set and, hence, control volume limits. The iPod® media player, manufactured by Apple Inc. of Cupertino, Calif., is one example of a device that includes such a volume control feature.

Existing mechanisms for controlling access to media generally do not address all the needs of parents. There is a growing need for managing media content on portable electronic devices, as the use of such devices is ever increasing. Therefore, improved methods and systems for managing media access and media content on portable electronic devices are desired.

### SUMMARY OF THE INVENTION

The present invention pertains to techniques that enable access to media stored or played on portable electronic media devices to be controlled. Such techniques allow parents to (i) limit the amount of time their children may access media, and/or (ii) control the type of media their children may access.

The present invention may be implemented in numerous ways, including, but not limited to, as a method, system, device, apparatus (including a graphical user interface), or computer readable medium. Example embodiments of the present invention are discussed below.

According to one aspect of the present invention, a method for controlling the use of features associated with a portable electronic device includes setting at least one constraint associated with access to a feature of the portable electronic device and processing a user request to access the feature. The method can also include determining whether the constraint indicates that the feature is currently accessible to the user, and permitting access to the feature when the indication is that the feature is currently accessible to the user. Finally, access to the feature is denied if the indication is that the feature is not currently accessible to the user.

According to another aspect of the present invention, a portable electronic media device that includes the capability to control access to at least one element associated with the device includes a first interface, a memory, and a device usage manager. The first interface is suitable for use in obtaining control information associated with an ability to access the element. The memory arrangement stores the control information and the element. The device usage manager obtains the control information from the memory and uses the control information to limit the ability of a user to access the element. The device usage manager can also determine whether access to the element by the user is allowed at a current time, prevents the user from accessing the element if it is determined that access to the element is not allowed at the current time, and allows the user access to the element if it is determined that access to the element is allowed at the current time.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, in which:

FIG. 1 is a block diagram representation of a portable electronic media player or device which includes a media control module in accordance with an embodiment of the present invention.

FIG. 2 is a block diagram representation of a portable electronic media player or device which is in communication with an external media control module in accordance with an embodiment of the present invention.

FIG. 3A is a process flow diagram which illustrates a method of using a portable electronic device on which a time allotment for use may be set in accordance with an embodiment of the present invention.

FIG. 3B is a process flow diagram which illustrates a method of using a portable electronic device on which time periods for use may be set in accordance with an embodiment of the present invention.

FIG. 4 is a process flow diagram which illustrates a method of using a portable electronic device on which use credits may be applied in accordance with an embodiment of the present invention.

FIG. 5 is a process flow diagram which illustrates a method of updating usage data in accordance with an embodiment of the present invention.

FIG. 6 is a process flow diagram which illustrates a method of setting limits or constraints associated with the use of a portable electronic device in accordance with an embodiment of the present invention.

FIG. 7 is a process flow diagram which illustrates a method of gaining access to a particular element associated with a portable electronic device in accordance with an embodiment of the present invention.

FIG. 8A is a process flow diagram which illustrates a method of ascertaining whether a media element is accessible in accordance with an embodiment of the present invention.

FIG. 8B is a process flow diagram which illustrates a method of ascertaining whether a phone number element is accessible in accordance with an embodiment of the present invention.

FIG. 9 is a process flow diagram which illustrates a method of employing an appropriate settings profile from a plurality of settings profiles associated with a portable electronic device in accordance with an embodiment of the present invention.

FIG. 10A is a diagrammatic representation of a display associated with a calendar application that allows times at which a user may access media to be selected in accordance with an embodiment of the present invention.

FIG. 10B is a diagrammatic representation of a display associated with a calendar application that allows times at which different users may access media to be selected in accordance with an embodiment of the present invention.

FIG. 11A is a diagrammatic representation of a display associated with a media control application that allows times at which a user may access media to be specified in accordance with an embodiment of the present invention.

FIG. 11B is a diagrammatic representation of a display associated with a media control application that allows times at which different users may access media to be specified in accordance with an embodiment of the present invention.

FIG. 12 is a diagrammatic representation of a system in which a time at which a user may access media are specified on a portable electronic media device which includes a selection wheel in accordance with an embodiment of the present invention.

### DETAILED DESCRIPTION OF THE INVENTION

The invention pertains to techniques that enable parents to limit or implement constraints on the amount of time their children may use a portable electronic media device. The techniques can be used to effectively specify certain types of media as being inaccessible to their children. As exposure to some media may have an undesirable impact on children, the ability to control the amount of time children are able to access media, as well as the ability to control the types of media to which children have access, enables parents to essentially manage their children's use of portable electronic media devices.

A portable electronic media device may be configured such that the periods of time during which the device may be used and/or the amount of time the device may be used are controllable. That is, parents may effectively program a portable electronic media device to prevent a particular user, or multiple users, from being able to play media except during specified periods of time and/or for only a certain amount of time each day. By essentially rendering a portable electronic media device useless to their child except during predetermined periods of time, parents may control the amount of time their child has access to media played on the device. Parents may also control the amount of time their child has access to media by only allowing a portable electronic media device to be used for a certain amount of time each day.

In addition to, or in lieu of, being arranged to allow the times during which a portable electronic media device may be used, the types of media which may be accessed on the device may be controlled. That is, parents may control the types of media that their children may be exposed to by effectively programming a portable electronic media device to substantially only allow access to certain types or instances of media. By way of example, a parent may configure a portable electronic media device to prevent video files with an “R” rating from being downloaded onto or played on the portable electronic media device, or a parent may specify that a particular song may not be played on the portable electronic media device by his or her child. The ability to control the types of media to which their children have access may provide parents with the security of knowing that their children will not be exposed to material that they believe to be inappropriate.

In one embodiment, a portable electronic device such as a cellular phone may be configured such that parents may control the use of the cellular phone by their child. For instance, parents may effectively render the cellular phone unusable during certain times, or unusable except for a certain amount of time a day. Additionally, parents may also control the phone numbers which may be dialed using the cellular phone. By way of example, parents may effectively program a cellular phone such that a particular number may never be dialed, or such that the particular number may only be dialed during certain times. The ability to control the use of a cellular phone by their children allows parents to keep a tighter rein on the overall usage of the cellular phone, and also allows parents to control the amount of communications between their children and certain parties.

A portable electronic media device may include substantially any device that is capable of displaying and/or playing various types of media including, but not limited to including, photo files, video files, audio files, and gaming files. For example, a portable electronic media device may be a portable media player such as an iPod® media device available commercially from Apple Inc. of Cupertino, Calif. Further, a portable electronic media device may be a portable device which provides access to the Internet and/or includes media playing capabilities, e.g., a cellular phone such as the iPhone™ communication device available commercially from Apple Inc.

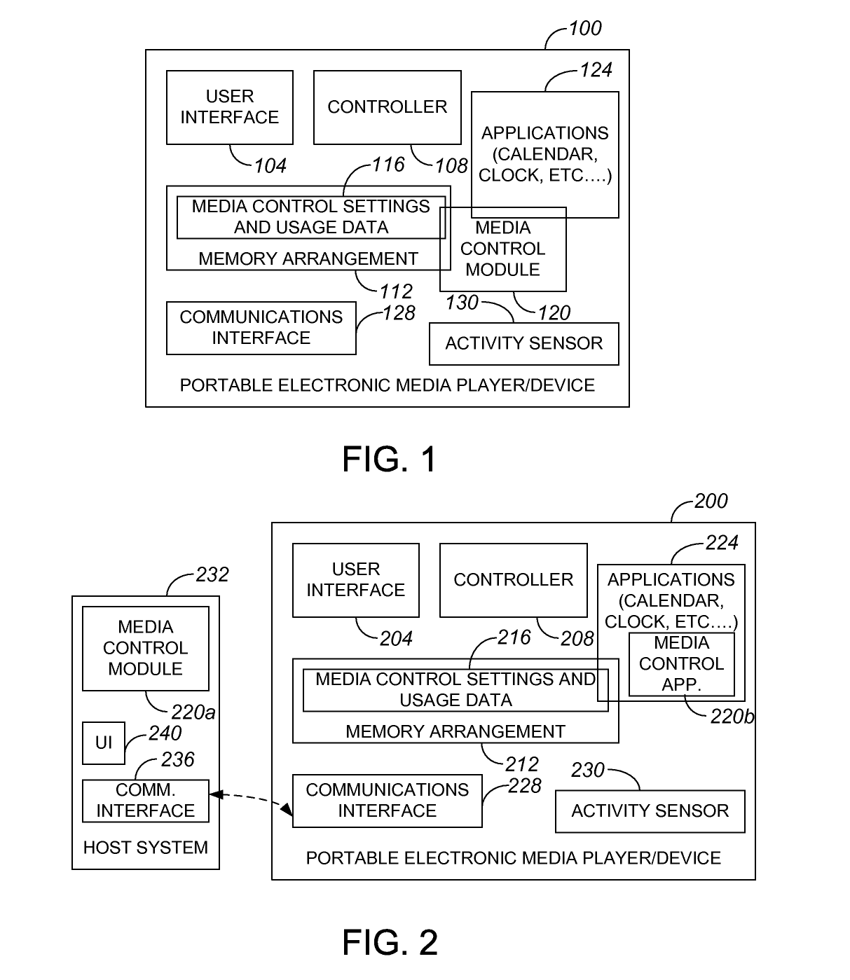

Referring initially to FIG. 1, a portable electronic device which includes parental controls, e.g., functionality that allows control over the usage of the device, will be described in accordance with an embodiment of the present invention. A portable electronic device 100 that includes parental controls may generally include a user interface 104 that allows device 100 to obtain inputs from both a parent who sets limits or constraints on use and a child who selects, for example, media to play on device 100. In one embodiment, user interface 104 may be a graphical user interface. Device 100 also includes a controller 108 that is arranged to control the operation of device 100, a communications interface 128 that allows device 100 to communicate with hosts, networks or other devices (not shown), and a memory arrangement 112 that may store various media files (not shown). Communications interface 128 can permit wired or wireless communication. Communications interface 128 allows media files to be uploaded from or downloaded to device 100, and allows software updates to be obtained by device 100.

A media control module 120 includes hardware and/or software logic that implements parental controls. Generally, media control module 120 is configured to allow parents to configure or otherwise set limits on access to various applications 124. In one embodiment, media control module 120 cooperates with applications 124 that execute on device 100 such that access to (or usage of) various applications 124, e.g., applications for media playing, games, network browsing, electronic messaging, online chatting, may be controlled or otherwise limited. For instance, media control module 120 may cooperate with a calendar application to limit the use of a media playing application to certain times of a day which may be specified using the calendar application. In addition, media control module 120 may cooperate with a media playback application to effectively render certain songs or videos as inaccessible.

Media control settings and usage data 116, which are used by media control module 120, may be stored in memory arrangement 112. Media control settings and usage data 116 may generally include (i) settings associated with limiting the amount of time device 100 may be used, and (ii) data that indicates how much device 100 has been used, as for example by particular users. By way of example, settings may include a maximum amount of time device 100 may be used during a given time period, while usage data may include the actual amount of time device 100 has been used. Usage data may generally be monitored, accumulated, and updated by media control module 120 and/or applications 124.

Device 100 may also include an activity sensor 130 (or activity monitor) which is arranged to sense when a user is attempting to use device 100. Activity sensor 130 may be arranged to sense when device 100 is powered on, and/or to sense when a potential user has attempted to access a feature of device such as an application that lists media (not shown) in memory arrangement 112.

While parental controls may be implemented substantially directly on a portable electronic device such as device 100, parental controls may instead be implemented on a host system (e.g., personal computer) that is in communication with a portable electronic device. When parental controls are implemented on a host system, a parent may effectively use the host system to provide constraints to a portable electronic device, i.e., a parent may interface with the host system to set limits on the portable electronic device. FIG. 2 is a block diagram representation of a portable electronic media player or device which is in communication with a host system in accordance with an embodiment of the present invention. A portable electronic device 200 may be in communication with a host system 232. In one embodiment, host system 232 includes a communications interface 236 which allows device 200 or, more specifically, a communications interface 228 of device 200 to couple (e.g., wired bus connection or dock) with host system 232. It should be appreciated, however, that host system 232 may instead communicate with device 200 through a wireless connection.

Host system 232 includes a user interface 240 that allows a parent to provide information to a media control module 220a that allows media control module 220a to set constraints on the accessibility of device 200. Information provided to media control module 220a via user interface 240 may be provided to a media control application 220b that is arranged to cooperate with other applications 224 to limit the use of device 200. More particularly, such information may be transferred from the media control module 220a or memory of host system 232 to the portable electronic device 200, for example, when device 200 is coupled with host system 232. The transferred information can be stored in a memory arrangement 212 as some or all of the media control settings and usage data. It should be appreciated that the capabilities associated with media control application 220b may be incorporated into other applications 224 such that media control application 220b is effectively not a standalone application. The media control module 220a can also be incorporated into an application, such as a media management application.

A user interface 204 of device 200 is arranged to receive inputs from a user that pertain to the operation of device 200. In other words, user interface 204 may be used to access applications 224. Media control settings and usage data 216, which are used by media control application 220b, may be stored into memory arrangement 212 by media control application 220b and/or media control module 220a. Media control settings and usage data 216 may include settings associated with (i) limiting or otherwise constraining the amount of time device 200 may be used, and (ii) data that indicates how much device 200 has been used, as for example by particular users. Usage data may generally be maintained by applications 224 and/or media control application 220b.

In the embodiment as shown, device 200 includes an activity sensor 230 (activity monitor) which is arranged to sense when a user is attempting to use device 200. As previously mentioned, activity sensor 230 may be arranged to sense when device 200 is powered on, and/or to sense when a potential user has attempted to access a feature of device such as an application that lists media (not shown) stored in memory arrangement 212.

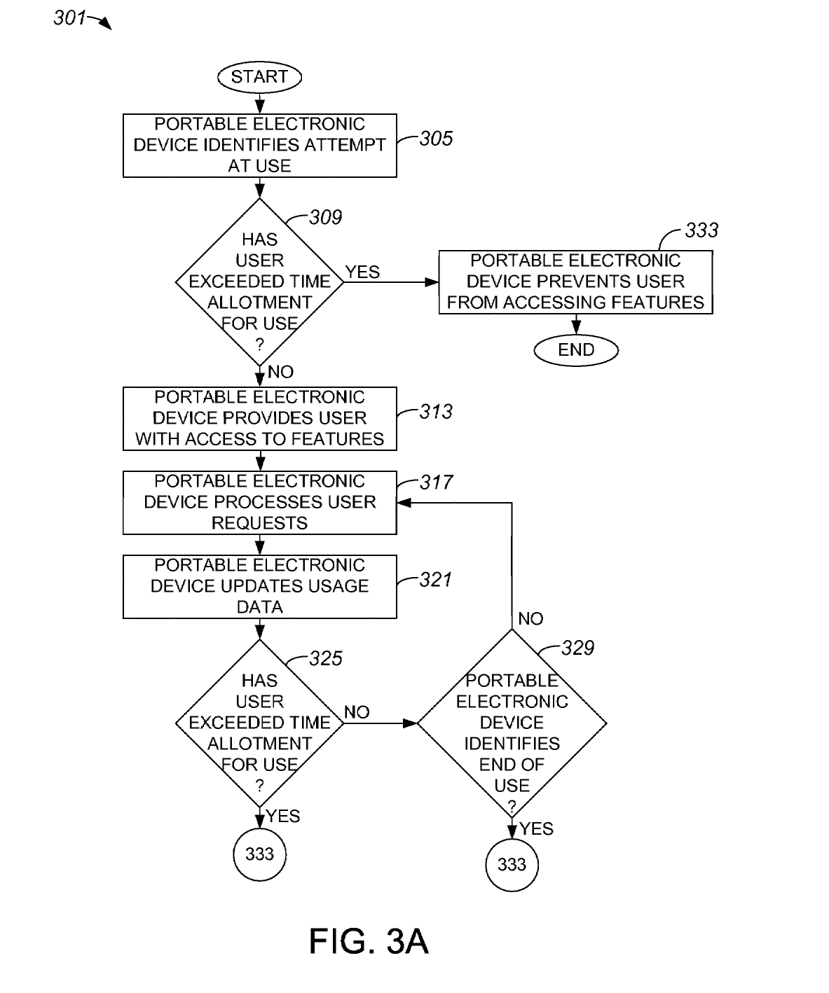

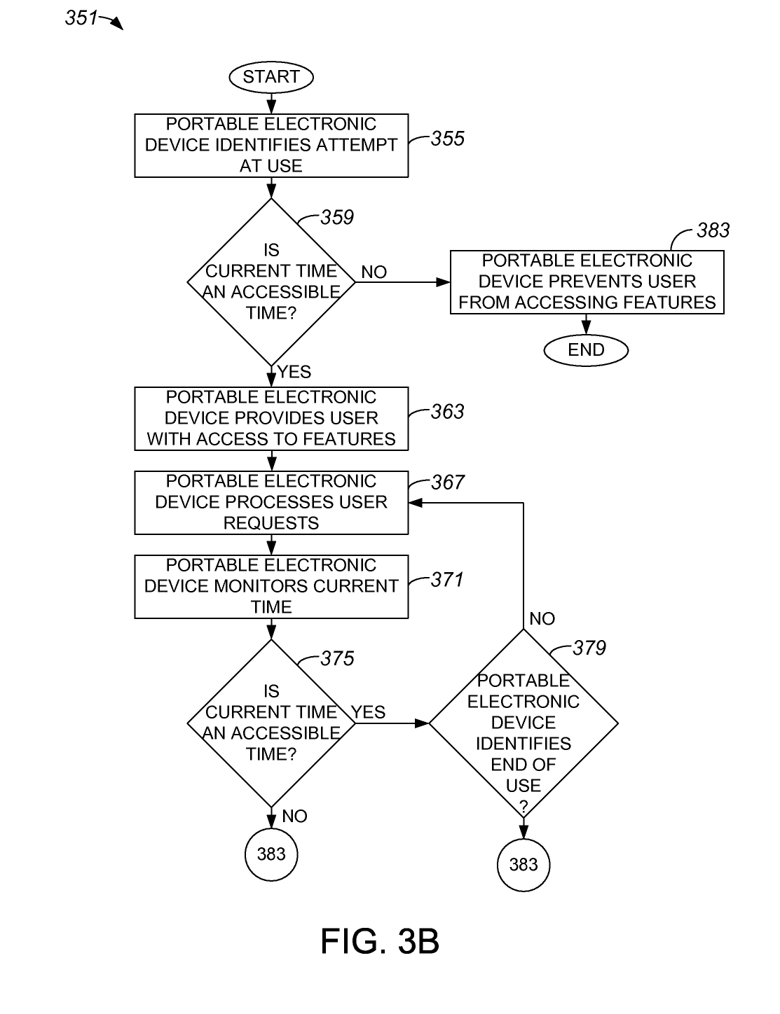

A portable electronic device may generally be configured such that a time allotment for use of the device or a time period during which the device may be used may be specified by parents, as for example using parental controls. With reference to FIG. 3A, a process of using a portable electronic device on which a time allotment for use may be set will be described in accordance with an embodiment of the present invention. A process 301 begins at step 305 in which a portable electronic device, e.g., a portable electronic media player or a cellular phone, senses or otherwise identifies an attempt at using the device. Identifying an attempt to use the device may include, but is not limited to including, identifying a powering on of the device, or identifying an instance of input received by the device. Such identifications may be made by a media control module, a media control application, and/or an activity sensor.

Once the portable electronic device determines that there has been attempt at use, it is determined whether the user attempting to use the device has exceeded his or her time allotment for use in step 309. It should be appreciated that the user may be an owner of a particular account on the device, or the user may be anyone who uses the device. In other words, a determination of whether a user has exceeded his or her time allotment for use may either involve determining whether an owner of an account has exceeded the time allotment for the account, or whether an overall time allotment for use of the device has been exceeded. Such a determination may include, but is not limited to including, determining if a usage time indicator has exceeded a maximum use time allotment or determining if a timer indicates that a maximum use time has been exceeded.

If it is determined that the user has exceeded a time allotment for use, or a maximum usage time, then the indication is that the user may not use the device. Accordingly, process flow proceeds to step 333 in which the device prevents the user from accessing features. In one embodiment, the device can continue to operate with certain features disabled. In another embodiment, preventing the user from accessing features may include powering down the device. The process of using a portable electronic device can be complete once the user is prevented from accessing features.

Alternatively, if it is determined in step 309 that the user has not exceeded a time allotment for use, then the user is permitted access to features of the device in step 313. Permitting the user with access to features may include, for example, fully powering on the device or displaying selection menus on a display screen of the device. Features of the device to which the user is provided access may include, but are not limited to including, content stored on the device like media files, media playback features, and/or dialing features that enable phone numbers to be dialed use the device.

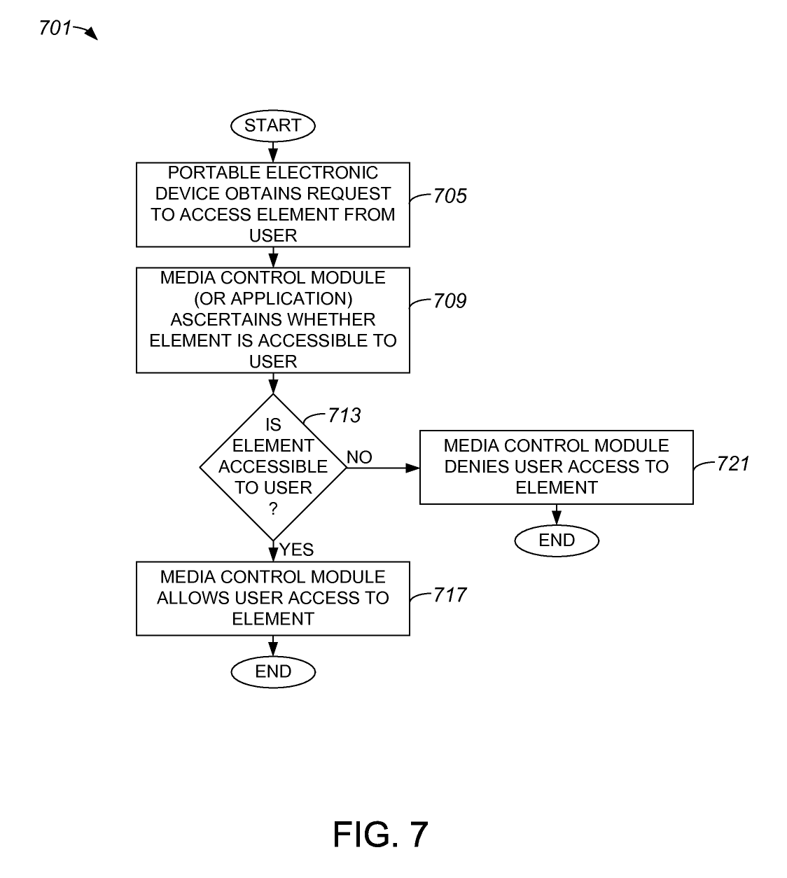

After the device provides the user with access to features, the device processes requests of the user in step 317. By way of example, the device may allow the user to listen to audio files, to view video files, and to dial phone numbers. It should be appreciated, as will be discussed below with respect to FIG. 7, that processing requests may include ascertaining whether certain files or phone numbers are accessible to the user.

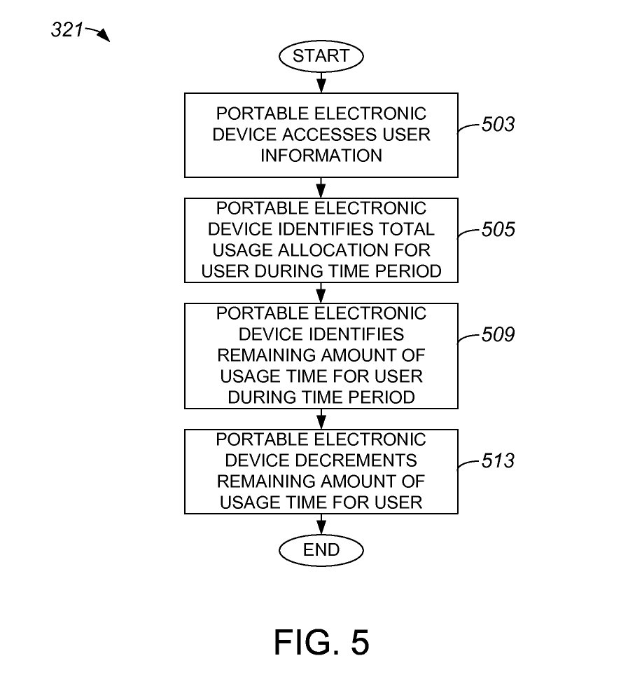

In step 321, the device updates usage data. That is, the device effectively keeps track of the amount of time the device has been in use, e.g., by the user. One method of updating usage data will be discussed below with respect to FIG. 5. Then, in step 325, it is determined whether the user has exceeded a time allotment for use of the device. Such a determination may be made by comparing usage data with a maximum time allotment. By way of example, if the maximum time allotment is associated with the overall use of the device, it may be determined if the usage data indicates that the maximum time allotment associated with the overall use of the device has been exceeded.

If it is determined in step 325 that the user has exceeded a time allotment for use, process flow proceeds to step 333 in which the device prevents the user from accessing features. Alternatively, if it is determined that the user has not exceeded a time allotment for use, then process flow moves to step 329 in which it is determined if an end of the usage of the device is identified. Identifying an end of use of the device may include determining if an attempt has been made to power down the device, determining if the charge on the device is relatively low, and determining if no user input has been received for more than a predetermined amount of time.

If the determination in step 329 is that an end of use has been identified, then the device prevents the user from accessing features in step 333. If, however, the determination in step 329 is that an end of use has not been identified, then process flow returns to step 317 in which the device processes requests of the user.

In lieu of being able to set a time allotment for the use of a portable electronic device, time periods during which a portable electronic device may be used may instead be set. FIG. 3B is a process flow diagram which illustrates a method of using a portable electronic device on which time periods for use may be set in accordance with an embodiment of the present invention. A process 351 of using a portable electronic device on which time periods for use may be set begins at step 355 in which a portable electronic device senses or otherwise identifies an attempt at using the device. As mentioned above, identifying an attempt to use the device may include identifying when the device has been powered on or when an input is received by the device.

When an attempt at use has been identified, it is determined in step 359 whether the current time is an accessible time. That is, it is determined whether the attempt at use the device has occurred during a time at which features of the device may be used, i.e., an accessible time is a time during which features of the device may be accessed by a user. It should be appreciated that if the device has many associated accounts, a determination of whether the current time is an accessible time may involve determining whether it is an accessible time associated with a particular user account.

If it is determined that the current time is not an accessible time, then the indication is that the user may not access features of the device. Accordingly, process flow proceeds to step 383 in which the device prevents the user from accessing features. The process of using a portable electronic device can be complete once the user is prevented from accessing features.

Alternatively, if it is determined in step 359 that the current time is an accessible time, then the user is permitted access to features of the device in step 363. After the device provides the user with access to features, the device processes requests of the user in step 367. In addition to processing requests of the user, e.g., allowing the user to utilize the device for intended purposes, the device monitors the current time in step 371. That is, the device effectively keeps track of the time.

In step 375, it is determined whether the current time is an accessible time. By way of example, if an accessible time period is defined by a beginning time and an ending time, it may be determined in step 375 whether the current time falls between the beginning time and the ending time. If it is determined in step 375 that the current time is not an accessible time, the indication is that an accessible time period has passed. Accordingly, process flow proceeds to step 383 in which the device prevents the user from accessing features.

Alternatively, if it is determined in step 375 that the current time is an accessible time, then a determination is made in step 379 as to whether an end of the usage of the device is identified. If the determination in step 379 is that an end of use has been identified, then the device prevents the user from accessing features in step 383. If, on the other hand, the determination in step 379 is that an end of use has not been identified, then process flow returns to step 367 in which the device processes requests of the user.

In lieu of specifying time allotments for use or accessible time periods, parents may assign “use credits” to their children that may be redeemed to access features on a portable electronic device. By way of example, a single use or usage credit may be redeemed in one embodiment to play audio files, video files, games, etc. on a portable electronic media player. The use credits may be entered or otherwise downloaded by parents into an account for their children on a portable electronic device. Alternatively, the use credits may be substantially automatically allocated based on a reward algorithm. In one embodiment, use credits may be substantially automatically rewarded based on actions taken by children. For instance, use credits may be substantially automatically rewarded when a child uses educational software which executes on a portable electronic device.

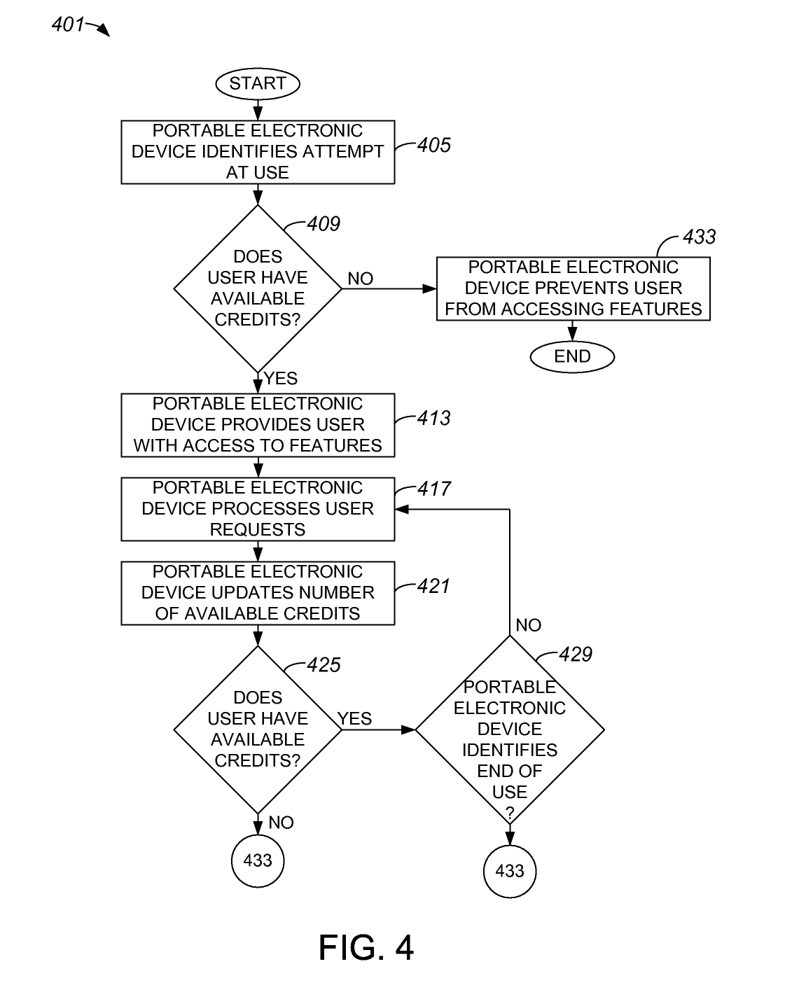

With reference to FIG. 4, a method of using a portable electronic device on which use credits may be applied will be described in accordance with an embodiment of the present invention. A process 401 of using a portable electronic device on which use credits may be redeemed begins at step 405 in which a portable electronic device senses or otherwise identifies an attempt at using the device. When an attempt at use has been identified, it is determined in step 409 whether the user who is attempting to use the device has available use credits. That is, it is determined whether there are a sufficient number of use credits available to allow for usage of the device. It should be appreciated that if the device has no individual accounts, a number of use credits may be associated with the overall use of the device by all users.

If the determination in step 409 is that there are no available use credits, then the indication is that the user may not access features of the device. Accordingly, process flow proceeds to step 433 in which the device prevents the user from accessing features. The process of using a portable electronic device can be complete once the user is prevented from accessing features.

Alternatively, if it is determined in step 409 that there are available use credits, then the user is permitted access to features of the device in step 413. After the device provides the user with access to features, the device processes requests of the user in step 417. Processing request may include, but is not limited to including, playing media files, playing games, browsing a network, electronic messaging, and/or online chatting. In the course of processing requests, the device effectively redeems, or updates the number of, use credits. In one embodiment, if each use credit is associated with access to a single media file, updating the number of use credits may include debiting the number of available use credits once the single media file is accessed. In another embodiment, if each use credit is associated with a particular number of minutes the device may be used, updating the number of use credits may include debiting the number of available use credits once the device is set to allow a user access for the particular number of minutes.

Once the number of available use credits is updated, it is determined in step 425 whether there are available use credits. If the determination in step 325 is that there are no available use credits, process flow proceeds to step 433 in which the device prevents the user from accessing features. Alternatively, if it is determined in step 425 that there are available use credits, it is then determined in step 429 if an end of the usage of the device is identified. If the determination in step 429 is that an end of use has been identified, then the device prevents the user from accessing features in step 433. If, however, it is determined in step 429 that an end of use has not been identified, then process flow returns to step 367 in which the device processes requests of the user.

One method of updating usage data, e.g., step 321 of FIG. 3A, will be described with respect to FIG. 5. FIG. 5 is a process flow diagram which illustrates a method of updating usage data in accordance with an embodiment of the present invention. A process 321 of updating usage data begins at step 503 in which a portable electronic device accesses user information. The user information may be associated with an account, e.g., an account stored on the device or an account that is remote relative to the device but is accessible to the device, for a particular user.

After the user information is accessed, the device identifies a total usage allocation assigned to the user for a particular time period in step 505. The particular time period may be widely varied. For example, the particular time period may be a day, a year, a month, a week, or a year. The total usage allocation may generally be stored in a memory or included in an application associated with the device. In one embodiment, the total usage allocation for a user may be stored in an account for the user. It should be appreciated that, in general, the device may have a single total usage allocation, instead of having usage allocations assigned to specific users. That is, a total usage allocation may be associated with the device, instead of with specific users of the device.

Once the total usage allocation for the time period is identified, the device identifies the remaining amount of usage time for the user during the time period in step 509. The remaining amount of usage time may be stored in a user account in a memory arrangement of the device, or in substantially any data structure in the memory arrangement. Upon identifying the remaining amount of usage time, process flow proceeds to step 513 in which the device causes the remaining amount of usage time to be decremented as appropriate. By way of example, if a user uses the device for two minutes, the remaining amount of usage time may be decremented by two minutes. Decrementing the remaining amount of usage time may involve a media control module or a media control application cooperating with a clock application to account for time during which the device is in use. The process of updating usage time can be complete after the remaining amount of usage time is appropriately decremented. As will be appreciated by those skilled in the art, in lieu of decrementing the remaining amount of usage time to update the usage time, a used amount of usage time may instead be incremented to update the usage time.

In general, controls such as parental controls that allow a parent to control the usage of a portable electronic device may either be implemented on the portable electronic device or on a host system with which the portable electronic device may communicate. Controlling the usage of a portable electronic device may include setting limits associated with the usage. Setting limits associated with the usage may include, but is not limited to including, determining a number of use credits to allocate to a user of a portable electronic device, determining time periods during which features of a portable electronic device may be accessed, and determining a total amount of time that a user may utilize a portable electronic device during a particular time period. These limits can be applied to particular users or particular devices. Further, these limits can be applied generally across various features or can be applied more specifically to type or categories of features. For example, different limits can be imposed depending on type of feature, e.g., media playback, game playing, network browsing, electronic messaging, and/or online chatting.

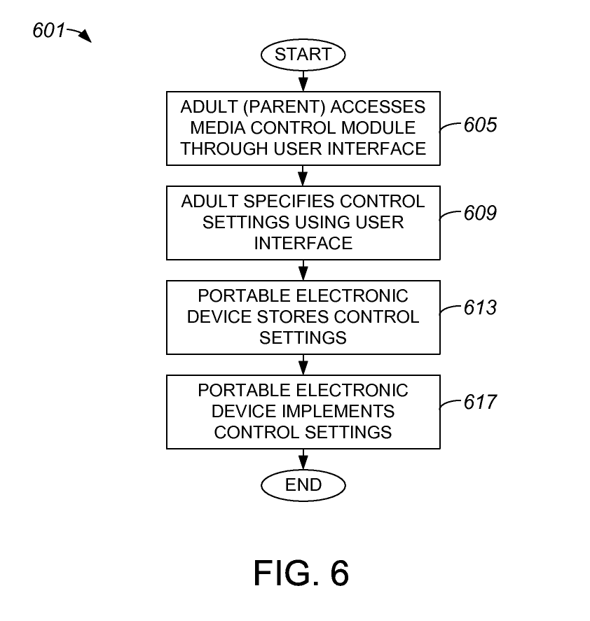

FIG. 6 is a process flow diagram which illustrates a method of setting limits associated with the use of a portable electronic device in accordance with an embodiment of the present invention. A process 601 of setting limits associated with the use of a portable electronic device begins at step 605 in which an adult accesses a media control module through a user interface. The media control module may either be located on the device, or on a host system that is in communication with the device. In one embodiment, the media control module may be distributed such that part of the media control module is located on a host system and part of the media control module is located on a portable electronic device. The user interface may be a graphical user interface.

An adult such as a parent may access the media control module using any suitable method. By way of example, some user interfaces may require that a password is entered before control limits may be set. User interfaces that require a password may require an “administrator” login. A user interface may display a total amount of available access time for the use of a portable electronic device, and the ability to modify the available access time, e.g., to add additional time to the available access time, may only be provided upon the entry of a password. The use of password may prevent a child from being able to credit himself or herself with additional access time. It should be appreciated that although a password may be used to prevent unauthorized access to user interfaces that allow modifications to available access time, use credits, etc., substantially any security feature may be used to prevent unauthorized access.

After the media control module is accessed by an adult, the adult may specify control settings in step 609 through the user interface. Specifying control settings may include, as previously mentioned, specifying a number of credits allocated to a user, specifying time periods during which features on the device may be accessed, and specifying a total amount of time for which features on the device may be used. Control setting may be specified using a variety of different methods. By way of example, a user interface may include a menu structure which allows control settings to be specified. Alternatively, a user interface may include radial buttons that may be selected to specify control settings, text fields that accept user input text, and/or a calendaring program that allows periods of accessibility to be selected.

Once control settings are specified, the control settings may be stored in step 613. The control settings may be stored locally with respect to the device, or may be stored remotely with respect to the device. Finally, in step 617, the control settings are implemented. That is, control settings are applied to the device. Upon implementing the control settings, the process of setting limits can be complete.

Parental controls may be used by parents to control the overall access their children have to a portable electronic media device, as discussed above. Additionally, parental controls may be used to control which elements associated with a portable electronic media device are actually accessible to a user. By way of example, parental controls may be used to specify particular types of media which are inaccessible, as well as particular instances of media which are inaccessible. A parent may specify that any video media that have more than a particular rating are inaccessible, or a parent may specify that particular videos are inaccessible irregardless of the ratings associated with the particular videos. If a portable electronic device is a cellular phone, elements which may be inaccessible may include particular phone numbers, e-mail addresses, and text messaging identifiers. A parent may limit the time during which a game can be played on the portable electronic device.

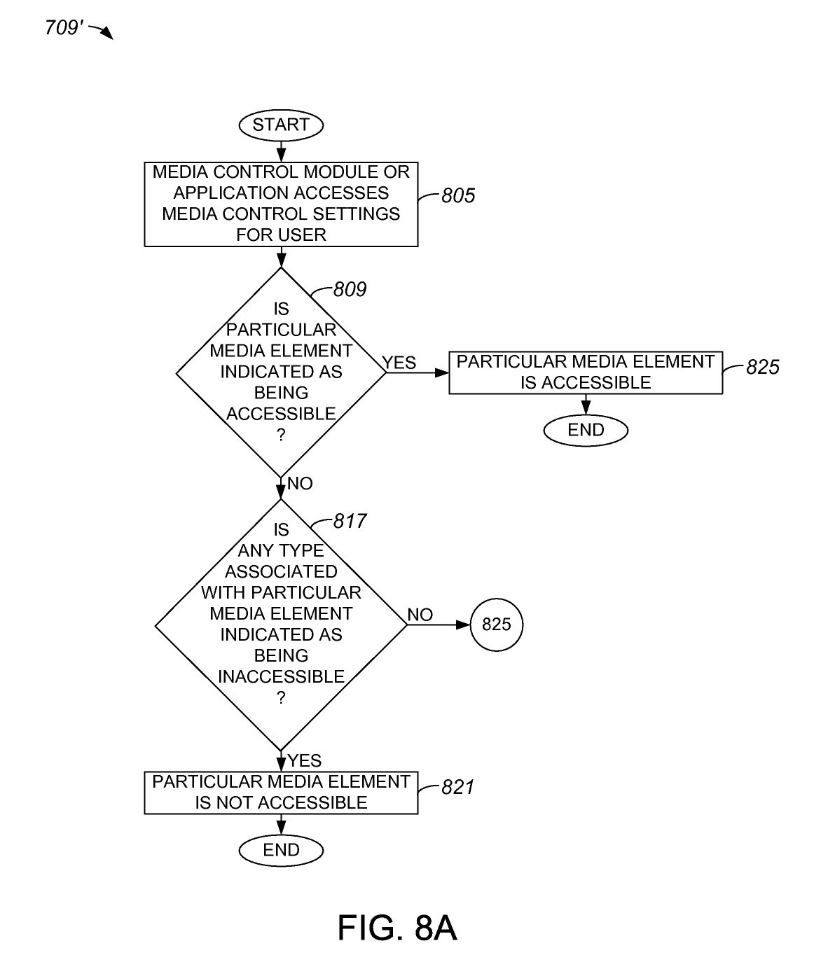

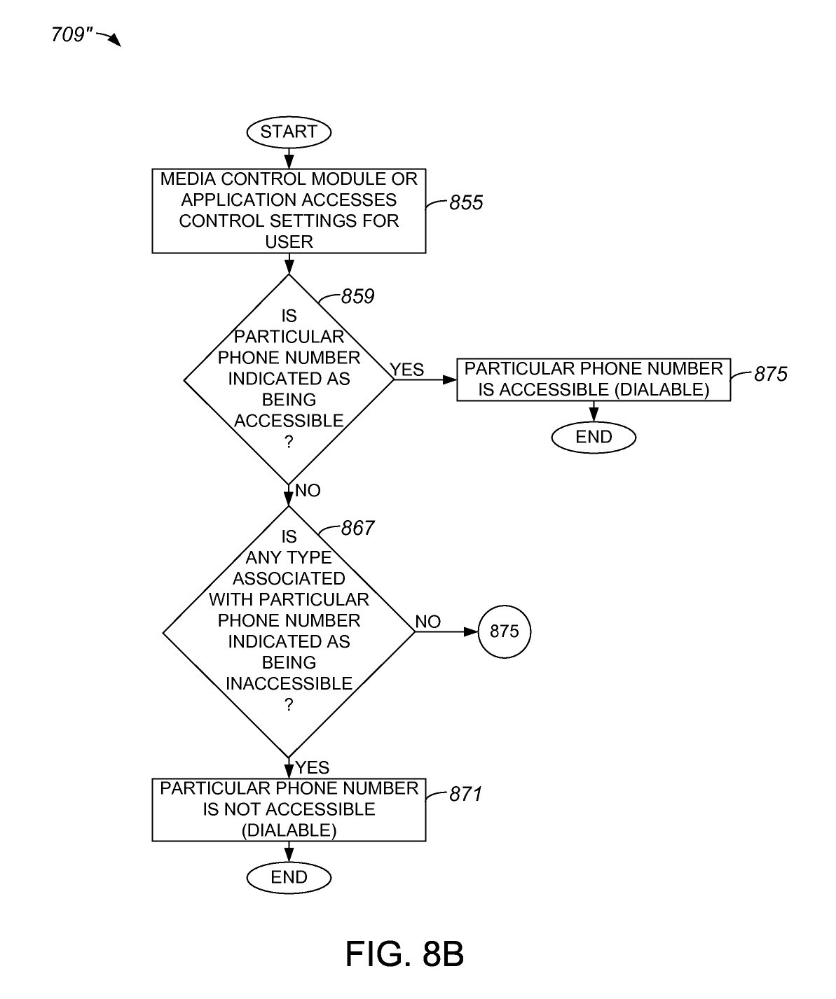

When a user of a portable electronic device attempts to access a particular element, the device determines if the user has permission to access the particular element. FIG. 7 is a process flow diagram which illustrates a method of gaining access to a particular element associated with a portable electronic device in accordance with an embodiment of the present invention. A process 701 of gaining access to a particular element begins at step 705 in which a portable electronic device obtains a request from a user to access an element. As previously mentioned, elements that are to be accessed may be widely varied, and may include media files and phone numbers to be dialed. Once a request to obtain access to an element is obtained, a media control module or media control application may ascertain whether the element is accessible to the user in step 709. Ascertaining whether the element is accessible may include accessing a memory arrangement to determine whether the element to be accessed is, itself, specified as not being accessible or if the element is of a type that is identified as not being accessible. One method of ascertaining whether a media element is accessible will be described below with reference to FIG. 8A, while one method of ascertaining whether a phone number element is accessible will be discussed below with reference to FIG. 8B.

From step 709, process flow proceeds to step 713 in which it is determined if the element is accessible to the user. If the determination is that the element is accessible to the user, the media control module or media control application allows the user to access the element in step 717. Allowing the user to access the element may include allowing the element to be played or dialed, as appropriate. Once the user accesses the element, the process of gaining access to a particular element can be complete.

Returning to step 713, if it is determined that the element is not accessible to the user, the indication is that the user does not have permission to access the element. Accordingly, process flow moves to step 721 in which the media control module or media control application denies the user access to the element. After access to the element is denied, the process of gaining access to a particular element can be complete.

With respect to FIG. 8A, a method of ascertaining whether a media element is accessible, e.g., step 709 of FIG. 7, will be described in accordance with an embodiment of the present invention. A process 709′ of determining whether a particular media element is accessible begins at step 805 in which the media control module of a portable electronic device accesses media control settings for a user. It should be appreciated that the media control settings may either be substantially universal such that all users are subject to the same control limits, or be substantially individualized such that each user with an account on the device is subject to personalized control limits.

A determination is made in step 809 as to whether the particular media element is indicated as being accessible. That is, it is determined whether appropriate control settings specify either directly or indirectly that the particular media element is accessible. If the determination in step 809 is that the particular media element is indicated as being accessible, e.g., stored settings indicate that the particular media element may be accessed, then the particular media element is considered as being accessible to the user in step 825, and the process of determining the accessibility of a particular media element can be complete.

Alternatively, if it is determined in step 809 that the particular media element is not indicated as being accessible, then in step 817, it is determined whether any type associated with the particular media element is indicated as being in accessible. Determining whether any type associated with the particular media element indicates that the particular media element is accessible includes, but is not limited to including, determining if the rating of the media element or if the genre associated with the media element is specified as being accessible to the user.

If it is determined in step 817 that a type associated with the particular media element is not inaccessible, then the particular media element is considered as being accessible in step 825, and the process of determining the accessibility of a particular media element can be complete. Alternatively, if the determination in step 817 is that a type associated with the particular media element is indicated as being inaccessible, then at step 821 the particular media element is considered as being inaccessible to the user, and the process of determining the accessibility of a particular media element can be complete.

Referring next to FIG. 8B, a method of ascertaining whether a phone number element is accessible for dialing by a user, e.g., step 709 of FIG. 7, will be discussed in accordance with an embodiment of the present invention. A process 709″ of determining whether a particular phone number element is accessible begins at step 855 in which the media control module of a portable electronic device accesses control settings for a user. The control settings may either be associated with a particular user, or may be applicable to substantially all users of the device.

It is determined in step 859 if the particular phone number that the user is attempting to dial or otherwise access is indicated as being accessible. That is, it is determined whether appropriate control settings specify either directly or indirectly that the particular phone number element is accessible. If the determination in step 859 is that the particular phone number element is indicated as being accessible, then the particular phone number element is considered to be dialable or otherwise accessible to the user in step 875, and the process of determining the accessibility of a particular phone number element can be complete.

If it is determined, however, in step 859 that the particular phone number element is not indicated as being accessible, it is then determined in step 867 whether any type associated with the particular media element is indicated as being in accessible. Determining whether any type associated with the particular phone number element indicates that the particular phone number element is accessible may include determining if the particular phone number element is classified as a phone number of a friend, a phone number of an emergency service, a phone number of a parent, or a long distance phone number. By way of example, phone numbers for friends and long distance phone numbers may be rendered as types of phone numbers that may not be accessed by a user.

If it is determined in step 867 that a type associated with the particular phone number element is not inaccessible, then the particular phone number element is considered as being accessible in step 825, and the process of determining the accessibility of a particular media element can be complete. Alternatively, if the determination in step 867 is that a type associated with the particular phone element is indicated as being inaccessible, then the particular phone number element is considered as being inaccessible to the user in step 871, and the process of determining the accessibility of a particular phone number element can be complete.

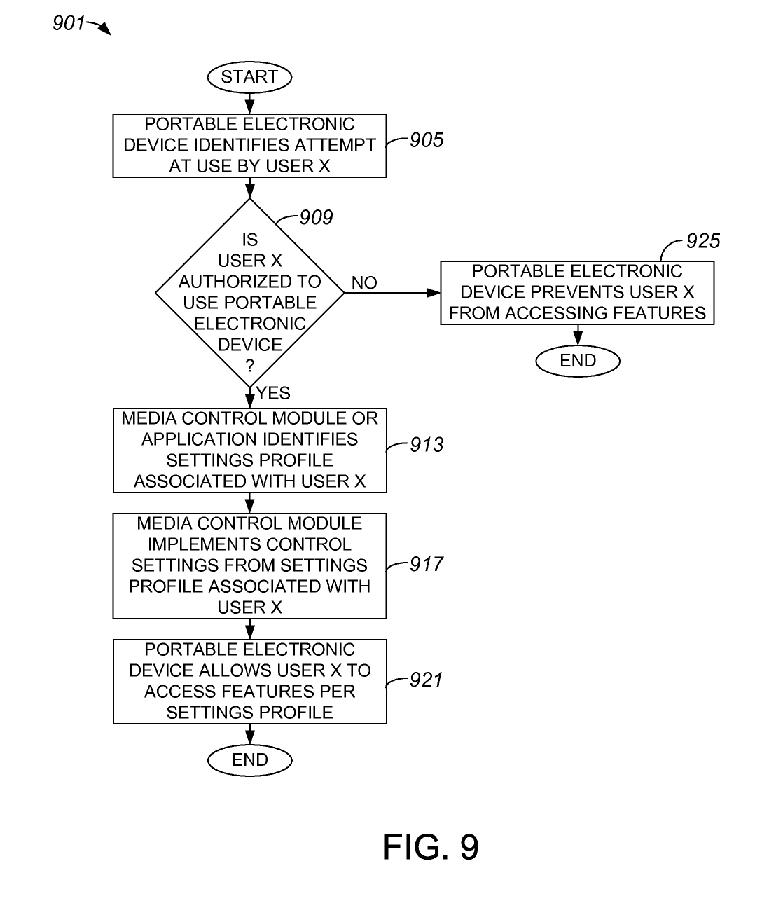

As previously mentioned, a portable electronic device may be arranged to have a substantially single settings profile or account that is shared by users of the device, and specifies limits or constraints that apply to substantially all users of the device. Alternatively, a portable electronic device may be arranged such that each authorized user of the device has his or her own settings profile that specifies limits appropriate to each individual authorized user. FIG. 9 is a process flow diagram which illustrates a method of employing an appropriate settings profile from a plurality of settings profiles associated with a portable electronic device in accordance with an embodiment of the present invention. A process 901 of employing an appropriate account or settings profile begins at step 905 in which a portable electronic device identifies an attempt by user “X” at using the device. The attempt at using the device may be identified, for example, if user “X” enters a password into the device or otherwise logs into the device.

A determination is made in step 909 regarding whether user “X” is authorized to use the device. In one embodiment, such a determination may be made by ascertaining whether user “X” has an individualized settings profile through a search of substantially all settings profiles associated with the device. If it is determined that user “X” is not authorized to use the device, user “X” is prevented from accessing features of the device in step 925, and the process of employing an appropriate settings profile is terminated.

Alternatively, if the determination in step 909 is that user “X” is authorized to use the device, the indication is that user “X” has an appropriate settings profile. Accordingly, process flow proceeds to step 913 in which the media control module of the device identifies the settings profile associated with user “X”. Upon identifying the settings profile associated with user “X”, the media control module implements the limits or control settings specified in the settings profile in step 917. After the limits or control settings are implemented or otherwise applied with respect to the device, user “X” is allowed to use the device in step 921. Using the device generally includes accessing those features to which user “X” is specified as having permission to access. The process of employing an appropriate settings profile can be complete once the user is allowed to access features of the device as specified in the settings profile.

Substantially any suitable user interfaces may be employed to allow a parent, for example, to set limits to be applied to the usage of a portable electronic device. For example, a user interface that is associated with a calendar application is suitable for use in setting times during which features of a portable electronic device are accessible. Although a calendar application may execute on the portable electronic device itself, the calendar application may preferably execute on a host system to which the portable electronic device may be docked or with which the portable electronic device may communicate.

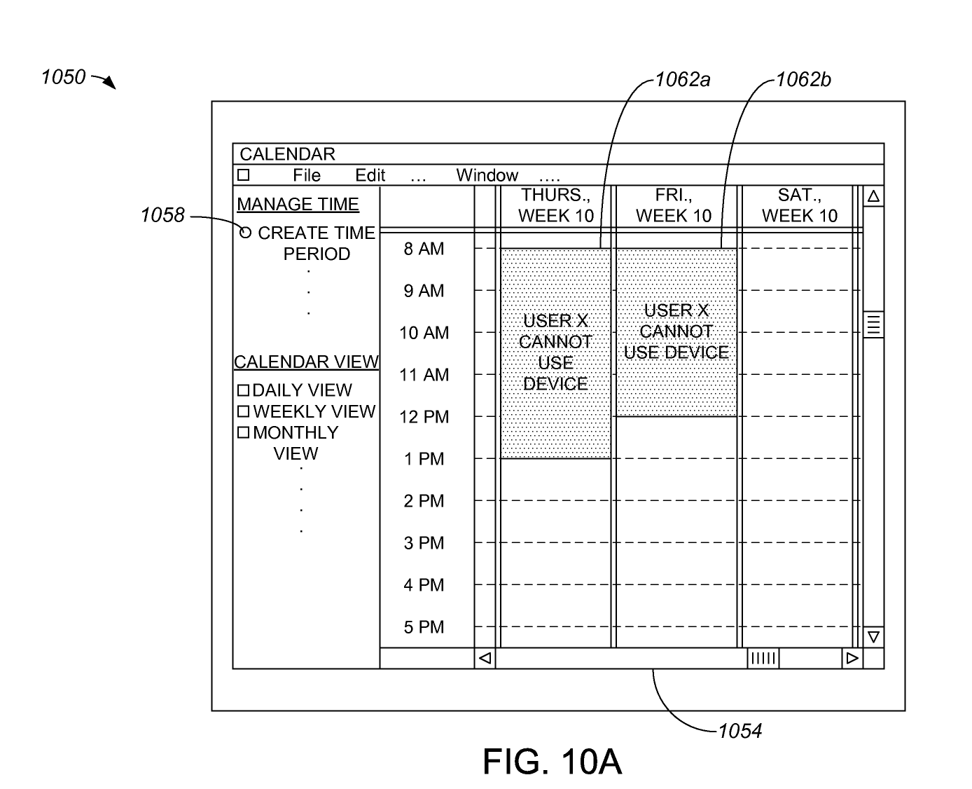

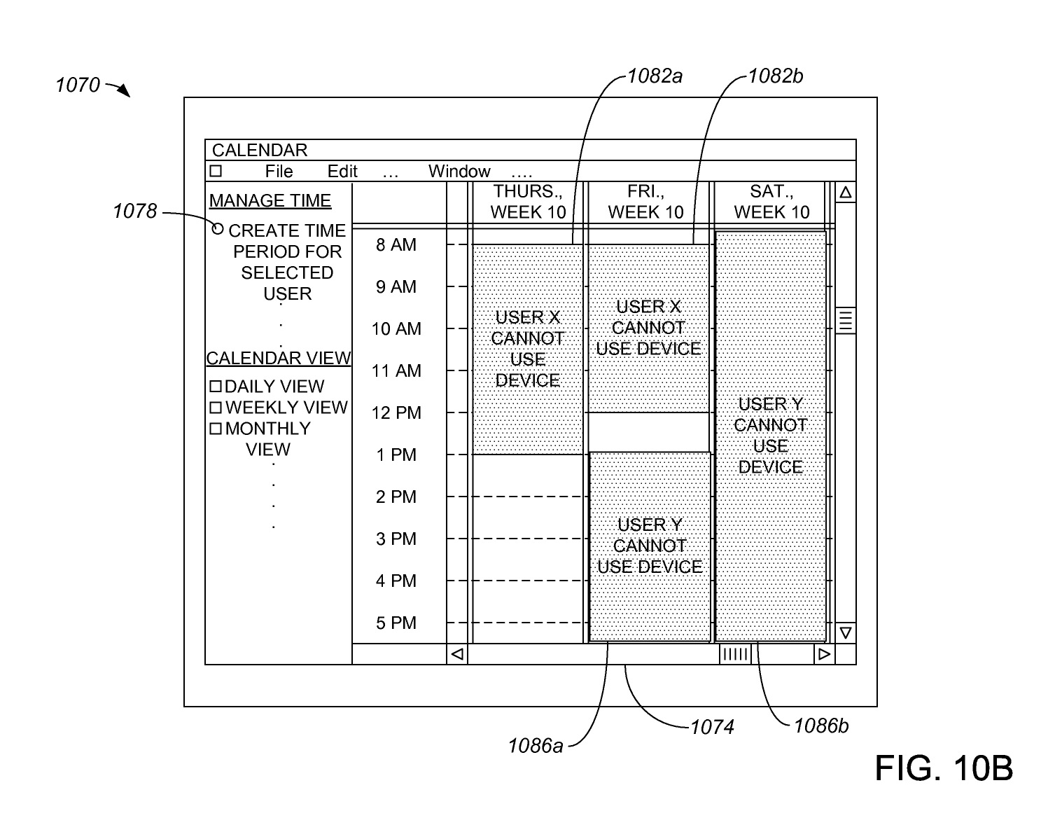

FIG. 10A is a diagrammatic representation of a display associated with a calendar application that allows times at which a user may access media using a portable electronic device to be selected in accordance with an embodiment of the present invention. A display 1050 includes a window 1054 on which at least a part of a calendar may be displayed. Calendar window 1054 includes a menu selection 1058 that allows time periods during which a device may be used to be defined. A parent who is setting time periods during which a child may or may not use a portable electronic device may define time periods 1062a, 1062 using substantially any suitable input mechanism including, but not limited to include, a stylus, a click-wheel, a touchpad, a mouse, a trackball, a touchscreen, and/or a keyboard. As shown, time periods 1062a, 1062b during which a particular user may not use the device are effectively blocked out. As will be appreciated by those skilled in the art, time periods 1062a, 1062b may be communicated by a calendaring application to other applications such that the device may be configured to prevent the particular user from using the device during time periods 1062a, 1062b. While time periods 1062a, 1062b are specified as times when features of the device are not accessible, time periods may instead be specified as times when features of the device are accessible.

Some calendar applications may be arranged to allow time periods for the accessibility or the inaccessibility of a portable electronic device to be defined for multiple users of the device. FIG. 10B is a diagrammatic representation of a display associated with a calendar application that allows times at which different users may access media to be selected in accordance with an embodiment of the present invention. A display 1070 includes a window 1074 on which a portion of a calendar may be displayed. Calendar window 1074 includes a menu selection 1078 that allows time periods during which a device may be used or not used by different users to be specified. Time periods 1082a, 1082b during which user “X” is prevented from accessing the device are defined, and time periods 1086a, 1086b during which user “Y” is prevented from accessing the device are defined. It should be understood that in lieu of specifying time periods 1082a, 1082b, 1086a, 1086b as times during which the device may not be used, time periods may instead be specified as times when the device may be used. Further, although time periods 1082a, 1082b are shown as not overlapping time periods 1086a, 1086b, time periods defined for different users may typically overlap.

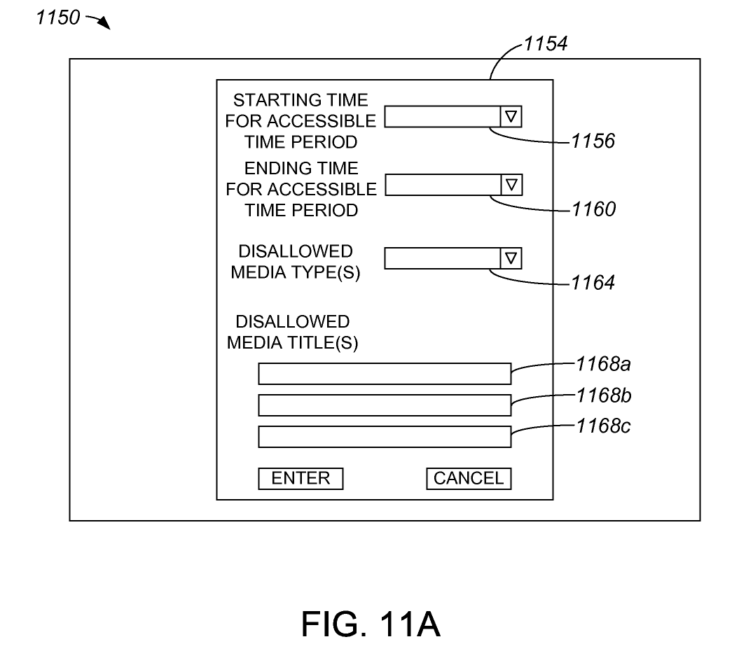

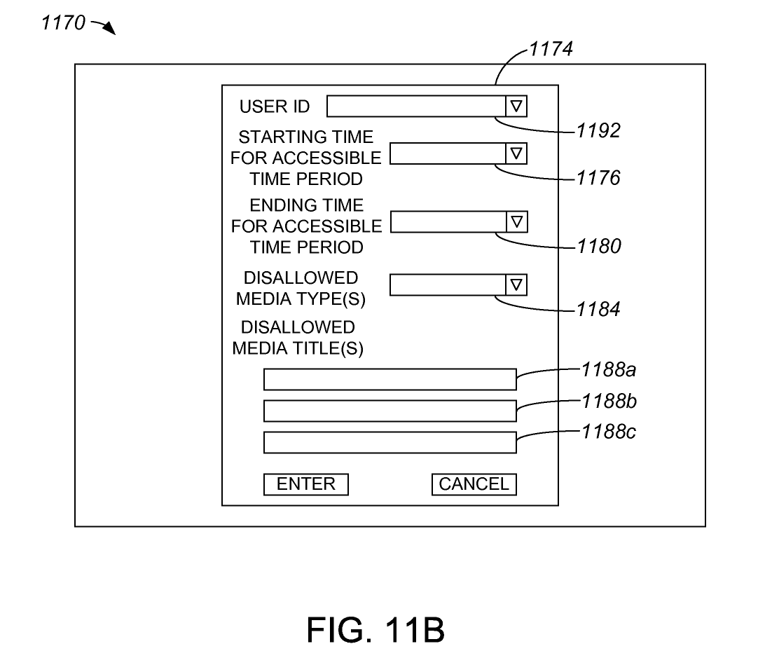

A calendar application is but one example of a suitable interface for use in effectively defining time periods during which a device may be used, e.g., during which features of a device may be accessed. In one embodiment, a media control application which executes either on a portable electronic device or a host system may be used to specify time periods during which a device may be used. With reference to FIG. 11A, a display associated with a media control application that allows times at which a user may access media to be specified will be described in accordance with an embodiment of the present invention. A display 1150 includes an interface window 1154 which provides fields 1156, 1160 into which starting times and ending times, respectively, for accessible time frames may be entered. Fields 1156, 1160 may accept text entries, or may effectively be populated using pulldown menus. In the described embodiment, window 1154 also provides a field 1164 into which disallowed media types may be entered, as well as fields 1168a-c into which disallowed media titles may be entered.

FIG. 11B is a diagrammatic representation of a display similar to display 1150 of FIG. 11A, but with the capability to allow times at which different users may access media to be specified in accordance with an embodiment of the present invention. A display 1170 includes an interface window 1174 which includes a field 1192 into which a user name may be entered. The user name that is entered may correspond to an authorized user of a portable electronic device for whom periods during which he or she may use the portable electronic device are to be specified. Interface window 1174 includes fields 1176, 1180 into which starting times and ending times, respectively, for accessible time frames may be entered. Interface window 1174 may also display a field 1184 into which disallowed media types may be entered, as well as fields 1188a-c into which disallowed media titles may be entered.

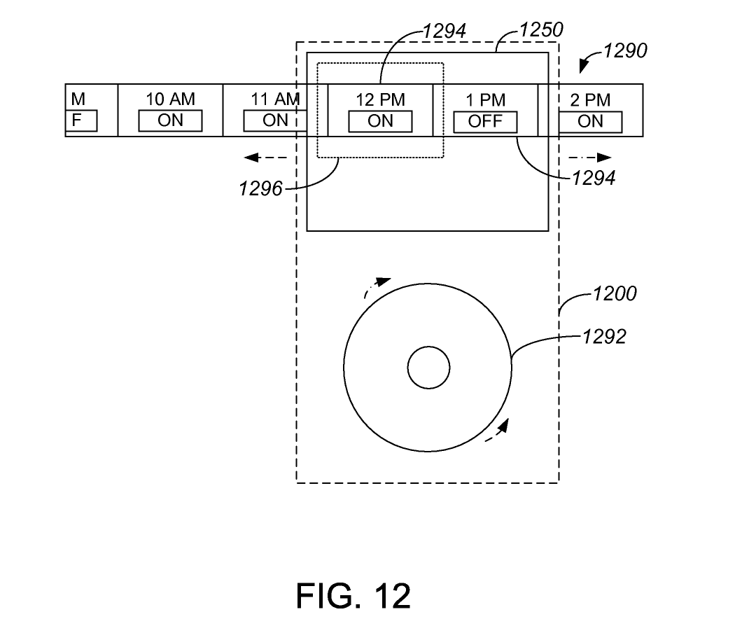

As mentioned above, the ability to set periods during which a user may access features of a portable electronic device may be provided to a device such as an iPod® media device. With reference to FIG. 12, one user interface that is particularly suitable interface that allows a parent to set times during which his or her child may use a portable electronic device will be described. FIG. 12 is a diagrammatic representation of a system in which a time at which a user may access media are specified on a portable electronic media device which includes a selection wheel (dial), physical or virtual, in accordance with an embodiment of the present invention. A portable electronic media device 1200 includes a display screen 1250 and a selection wheel 1292. A calendar representation 1290 or, more specifically, a timeline representation associated with a calendar, is at least partially displayed on screen 1250. By using selection wheel 1292, calendar representation 1290 may effectively be scrolled relative to screen 1250.

Calendar representation 1290 includes time increments 1294. As shown, a current time increment 1294 that is being set is highlighted by a selection zone 1296. In one embodiment, by clicking on selection wheel 1292, the time increment 1294 that is highlighted in selection zone 1296 may be set to either indicate that device 1200 is usable during that time, as shown, or not usable during that time. It should be appreciated that time increments 1294 may apply daily, weekly, monthly, or yearly. By way of example, in the embodiment as shown, calendar representation 1290 may be used to specify that device 1200 may be used by a user at 12 pm on a particular day, on particular days, or every day.

Although only a few embodiments of the present invention have been described, it should be understood that the present invention may be embodied in many other specific forms without departing from the spirit or the scope of the present invention. By way of example, a portable electronic device has been described as either having a substantially single shared account that specifies universal limits for the device, or individualized accounts for authorized users that specify limits for each individual user. However, in one embodiment, a portable electronic device may include both individualized accounts or settings profiles, and a “guest” account or settings profile that specifies limits for substantially all users who do not effectively own individualized accounts.

Particular media types, e.g., digital music files or digital video files, have generally been described as being substantially always inaccessible or substantially always accessible. In one embodiment, a particular media type may be inaccessible during particular time periods, or accessible during particular time periods. By way of example, a time period during which otherwise inaccessible media types are accessible may be set with respect to a portable electronic media player.

Both a time allotment for use of a portable electronic device and a time period during which a portable electronic device may be used have been described as being set using parental controls. It should be understood, however, that a time allotment for use and a time period during which a device may be used may be combined. For instance, a user of a device may be allowed to access features of device for a given number of minutes only during predetermined periods of time. Further, parents may specify that use credits are only redeemable to access features of a device substantially only during predetermined periods of time without departing from the spirit or the scope of the present invention.

Some portable electronic devices may be arranged to execute educational software or run educational applications. By way of example, some portable electronic devices may be arranged to run educational applications which teach math, languages, science, art, and other subjects. The allocation of access time and/or use credits may be tied to the use of the educational applications without departing from the spirit or the scope of the present invention. In one embodiment, if an educational application is used for a particular number of minutes, the access time associated with a portable electronic device may be increased by the particular number of minutes. Alternatively, if an educational application is not used for at least a particular number of minutes, the access time associated with a portable electronic device may be decreased by the particular number of minutes.

Portable electronic devices that run educational applications may be configured to allow access to resources substantially only after educational applications are run. For example, a portable electronic device may be configured such that educational applications are substantially always accessible, while other resources are not accessible except for just after the education applications are run. In one embodiment, the use of an educational application by a child for an amount of time ‘X’ may result in the child being allowed to access the resource of his or her choice substantially immediately thereafter for an amount of time ‘Y’.

It should be appreciated that limits may be set such that one limit applies to substantially all features of a portable electronic media device. In other words, limits may either be set substantially universally. For instance, a volume limit may be set that applies to all types of media at substantially all times, or an access time period may be set such that all media are accessible during the time period, and inaccessible otherwise. Alternatively, however, limits may be set such that separate limits apply to different features. That is, different features and/or media types may have their own limits. For example, volume limits may be set such that one type of media has a higher volume limit than another type of media. As another example, access time periods may be set such that one type of media may be accessed substantially only during a first time period while another type of media may be accessed substantially only during a second time period.

Further, limits or controls may be set such that certain features are accessible while others are not. By way of example, for a portable electronic device such as a cellular phone, text messaging features may be limited to being accessible substantially only during certain time periods, while dialing features may be accessible substantially all the time without departing from the spirit or the scope of the present invention. In one embodiment, parental controls may be implemented such that a parent provides his or her child with a password that is needed to access features of a portable electronic device. Such a password may be arranged to expire when the patent no longer wants the features to be accessible to his or her child.

The invention is preferably implemented by software, hardware, or a combination of hardware and software that is associated with a portable electronic media device. The invention may also be embodied as computer readable code, code devices, or logic on a computer program product such as a computer readable medium. The computer readable medium is typically any data storage device that may store data which may thereafter be read by a computer system that is interfaced with a portable electronic media device, or by a portable electronic media device itself. Examples of the computer readable medium include, but are not limited to including, flash memory, read-only memory, random-access memory, CD-ROMs, DVDs, magnetic tape, optical data storage devices, and carrier waves. The computer readable medium may also be distributed over network-coupled computer systems so that the computer readable code is stored and executed in a distributed fashion.

The steps associated with the methods of the present invention may vary widely. Steps may be added, removed, altered, combined, and reordered without departing from the spirit of the scope of the present invention. Therefore, the present examples are to be considered as illustrative and not restrictive, and the invention is not to be limited to the details given herein, but may be modified within the scope of the appended claims.

What is claimed is:

1. A method for controlling the use of features associated with a portable electronic device, the method comprising:
processing a request to access a feature, the request being initiated by a user;
determining whether at least one constraint indicates that the feature is currently accessible to the user, the at least one being associated with access to a feature of the portable electronic device;
permitting access to the feature when it is determined that the at least one constraint indicates that the feature is currently accessible to the user; and
denying access to the feature when it is determined that the at least one constraint indicates that the feature is not currently accessible to the user.

2. The method of claim 1 wherein the at least one constraint is a time period during which the feature is accessible, and determining whether the at least one constraint indicates that the feature is currently accessible to the user includes determining if a current time falls within the time period.

3. The method of claim 1 wherein the at least one constraint is a maximum amount of time associated with access to the portable electronic device, and the method further includes obtaining an indication of how much time the user has accessed the portable electronic device, wherein determining whether the at least one constraint indicates that the feature is currently accessible to the user includes comparing the maximum amount of time to the indication to determine whether the feature is currently accessible to the user.

4. The method of claim 1 wherein the at least one constraint is a number of credits needed to access the feature, and the method further includes obtaining an indication of how many available credits the user has for use in accessing the portable electronic device, wherein determining whether the at least one constraint indicates that the feature is currently accessible to the user includes comparing the number of credits needed to access the feature to the indication to determine whether the feature is currently accessible to the user.

5. The method of claim 1 wherein setting the at least one constraint associated with access to the feature of the portable electronic device includes obtaining the at least one constraint.

6. The method of claim 1 wherein the at least one constraint is a time period during which the feature may be accessed, a total amount of time during which the feature may be accessed, and an indication of whether the feature is accessible to the user.

7. The method of claim 1 wherein the feature is an application, a media file, or a phone number element.

8. The method of claim 1 wherein the feature pertains to at least one of media playing, game playing, network browsing, electronic messaging, or online chatting.

9. The method of claim 1 wherein the portable electronic device is a portable electronic media player or a cellular phone.

10. A computer program product suitable for controlling the use of features associated with a portable electronic device, the computer program product comprising:
code devices that set at least one constraint associated with access to a feature of the portable electronic device;
code devices that process a request to access the feature, the request being obtained from a user;
code devices that determine whether the at least one constraint indicates that the feature is currently accessible to the user;
code devices that permit access to the feature when it is determined that the at least one constraint indicates that the feature is currently accessible to the user; and
code devices that deny access to the feature when it is determined that the at least one constraint indicates that the feature is not currently accessible to the user.

11. The computer program product of claim 10 wherein the at least one constraint is a time period during which the feature is accessible, and the code devices that determine whether the at least one constraint indicates that the feature is currently accessible to the user include code devices that determine if a current time falls within the time period.

12. The computer program product of claim 10 wherein the at least one constraint is a maximum amount of time associated with access to the portable electronic device, and the computer program product further includes code devices that obtain an indication of how much time the user has accessed the portable electronic device, wherein the code devices that determine whether the at least one constraint indicates that the feature is currently accessible to the user include code devices that compare the maximum amount of time to the indication to determine whether the feature is currently accessible to the user.

13. The computer program product of claim 10 wherein the at least one constraint is a number of credits needed to access the feature, and the computer program product further includes code devices that obtain an indication of how many available credits the user has for use in accessing the portable electronic device, wherein the code devices that determine whether the at least one constraint indicates that the feature is currently accessible to the user include code devices that compare the number of credits needed to access the feature to the indication to determine whether the feature is currently accessible to the user.

14. The computer program product of claim 10 wherein the at least one constraint is a time period during which the feature may be accessed, a total amount of time during which the feature may be accessed, and an indication of whether the feature is accessible to the user.

15. A portable electronic device arranged to control access to at least one element associated with the portable electronic device, the portable electronic device comprising:
a first interface, the first interface being suitable for obtaining control information associated with an ability to access the at least one element;
a memory that stores the control information and the at least one element; and
a device usage manager, the device usage manager being suitable for obtaining the control information from the memory and using the control information to limit the ability of a user to access the element, the device usage manager being arranged to determine whether access to the element by the user is allowed at a current time and to prevent the user from accessing the element if it is determined that access to the element is not allowed at the current time, wherein the device usage manager is further arranged to allow the user access to the element if it is determined that access to the element is allowed at the current time.

16. The portable electronic device of claim 15 wherein the first interface is a calendaring interface and the control information is at least one time period during which the at least one element is accessible to the user, and wherein the calendaring interface is arranged to allow the at least one time period to be defined.

17. The portable electronic device of claim 15 wherein the first interface is arranged to obtain the control information from a host system.

18. The portable electronic device of claim 17 wherein the first interface is arranged to obtain the control information from the host system when the portable electronic device is coupled with the host system.

19. The portable electronic device of claim 15 wherein the control information is a time period during which access to the at least one element by the user is allowed, and wherein the device usage manager is arranged to determine whether access to the element by the user is allowed at the current time through determining if the current time falls within the time period.

20. The portable electronic device of claim 15 wherein the control information is a total amount of time for which access to the at least one element is allowed, and wherein the first arrangement is arranged to determine whether access to the element by the user is allowed through determining if usage information associated with the user indicates that the total amount of time is not exceeded.

21. The portable electronic device of claim 20 wherein the usage information is stored in the memory, and the device usage manager is further arranged to obtain the usage information from the memory arrangement.

22. The portable electronic device of claim 15 wherein the control information is a number of credits needed to access the at least one element, and wherein the device usage manager is arranged to determine whether access to the element by the user is allowed through determining if the user has sufficient use credits to permit access to the at least one element.

23. The portable electronic device of claim 22 wherein the use credits are stored in the memory, and the device usage manager is further arranged to obtain the use credits from the memory.

24. The portable electronic device of claim 15 wherein the portable electronic device is a portable electronic media player or a cellular phone.

25. The portable electronic device of claim 15 wherein the at least one element is an application, a phone number, or a media file.

26. The portable electronic device of claim 15 wherein the first interface is protected by a security feature, and the first interface is arranged to obtain the control information if the security feature allows.

27. The portable electronic device of claim 26 wherein the security feature is password protection, and the first interface is arranged to obtain the control information if a password is provided using the first interface.

28. The portable electronic device of claim 15 wherein the first interface is coupled to an application, and the first interface obtains the control information from the application.

29. The portable electronic device of claim 28 wherein the application is an educational application, and the control information is associated with the usage of the educational application.
